(19) United States
(12) Patent Application Publication
(10) Pub. No.: US 2024/0192441 A1
(43) Pub. Date: Jun. 13, 2024

(54) HETEROGENEOUSLY INTEGRATED SENSOR

(71) Applicant: Nexus Photonics, Inc., Goleta, CA (US)

(72) Inventors: Tin KOMLJENOVIC, Goleta, CA (US); Charles ROXLO, Saratoga, CA (US)

(73) Assignee: Nexus Photonics, Inc., Goleta, CA (US)

(21) Appl. No.: 18/076,819

(22) Filed: Dec. 7, 2022

(51) Int. Cl. G02B 6/122; G02B 6/12

(52) U.S. Cl. CPC G02B 6/1228; G02B 6/12004; G02B 2006/12109; G02B 2006/12147

(57) ABSTRACT

A device comprises at least one of the first, second and third elements fabricated on a common substrate. At least one of the first elements comprises an active waveguide structure supporting an active optical mode. At least one of the second elements comprises a passive waveguide structure supporting a passive optical mode. At least one of the third elements, at least partly butt-coupled to at least one of the first elements, comprises an intermediate waveguide structure supporting intermediate optical modes. At least one of the second elements comprises at least one input/output structure configured to interact with an analyte region and at least one of the first elements comprises an optical source. Mutual alignments of the elements are defined using lithographic alignment marks.

### FIELD OF THE INVENTION

The present invention relates to photonic integrated circuits. More specifically, certain embodiments of the invention relate to improved performance of heterogeneously integrated sensor and related components with improved performance.

### BACKGROUND OF THE INVENTION

A photonic integrated circuit (PIC) is a device that integrates multiple photonic functions and as such is analogous to an electronic integrated circuit. The major difference between the two is that a photonic integrated circuit provides functions imposed on optical carrier waves. A photonic integrated circuit can also generate light with advanced properties in one chip. The material platform most commercially utilized for photonic integrated circuits is indium phosphide (InP), which allows for the integration of various optically active and passive functions on the same chip. Although many current PICs are realized in InP platforms, there has been significant research in the past decade in using silicon rather than InP for the realization of PICs, due to some superior characteristics as well as superior processing capabilities for the former material, that leverage the investment already made for electronic integrated circuits.

The biggest drawback in using silicon for PICs is that it is an indirect bandgap material which makes it hard to provide electrically pumped sources. This problem is generally solved by assembling PICs comprising two or more chips made from dissimilar materials in separate processes. Such an approach is challenging due to a need for very fine alignment, which increases packaging costs and introduces scaling limitations. Another approach to solving the bandgap problem is to bond two dissimilar materials and process them together, removing the need for precise alignment during the bonding of larger pieces or complete wafers of the dissimilar materials, and allowing for mass fabrication. In this disclosure, we use the term “hybrid” to describe the first approach that includes precise assembly of separately processed parts, and we use the term “heterogeneous” to describe the latter approach of bonding two materials and then processing the bonded result to define the waveguides and other components of interest.

To transfer the optical signal between dissimilar materials, the heterogeneous approach utilizes tapers whose dimensions are gradually reduced until the effective mode refractive indexes of dissimilar materials match and there is efficient power transfer. This approach generally works well when materials have small difference in refractive indexes as is the case with silicon and InP. In cases where there is larger difference in effective indexes, such as between e.g., SiN and GaAs or InP, the requirements on taper tip dimensions become prohibitive limiting efficient power transfer. Specifically, extremely small taper tip widths (of the order of tens of nanometers) may be necessary to provide good coupling. Achieving such dimensions is complex and may be cost prohibitive.

Although InP and silicon-based PICs address many current needs, they have some limitations; among them are the fact that the operating wavelength range is limited by material absorption increasing the losses, lower thermal stability and the fact that there is a limit on the maximum optical intensities and consequently optical powers that a PIC can handle. To address these limitations, alternate waveguide materials have been considered, such as SiN, SiNOx, LiNbO₃, TiO₂, Ta₂O₅, AlN or others. In general, such dielectric waveguides have higher bandgap energies which provides better high-power handling and transparency at shorter wavelength, but, in general such materials also have lower refractive indexes. E.g., SiN with bandgap of ˜5 eV has refractive index of ˜2, AlN has bandgap of ˜6 eV and refractive index of around ˜2, and SiO₂ with bandgap of ˜8.9 eV has refractive index of ˜1.44. For comparison, the refractive index of both InP and GaAs is >3. This makes the tapered approach challenging.

The alternative hybrid approach suffers from the drawbacks already mentioned above, namely the need for precise alignment, and correspondingly complex packaging and scaling limitations.

A recent approach to the problems discussed above was presented in U.S. Pat. No. 10,859,764 B2 employing butt-coupling in combination with a mode-converter to allow the heterogenous process to be used without the need for extremely small taper widths.

Here we describe a heterogeneously integrated sensor and related components with improved performance that leverages benefits of using dissimilar materials for improved performance. Compared to prior approaches, the heterogeneously integrated sensor enables operation in ultrabroadband wavelength range from as short as ultra-violet (UV) to as long as mid-infrared (MIR) and beyond utilizing widely transparent materials and waveguides to guide, split and shape the light, and utilizes state-of-the-art direct electrically pumped semiconductor sources, amplifiers, modulators and detectors. The use of waveguide materials that can be precisely patterned, etched and (re)deposited enables significantly higher performance of the light shaping elements such as edge emitting or surface emitting structures further improving the performance compared to current assembled systems mostly utilizing light-emitting diodes (LEDs), vertical-cavity surface-emitting lasers (VSCELs) or edge-emitting lasers with corner reflector structures or similar. Furthermore, the ability to integrate more advanced laser structures such as widely tunable lasers and/or comb sources, together with ability to control both the amplitudes and phases of the emitted signals enables more precise measurements as will be described below. Finally, in some embodiments the utilization of dual-comb sources enables yet further improvement in performance while retaining very small size/weight due to leveraging wafer-scale integration of multiple photonic components. Integration also enables total system power reduction (due to reducing the coupling losses via advanced integration) as well as reduced cost at scale due to wafer-scale manufacturing and testing enabled by the heterogeneous integration.

The present invention is directed towards improving the state-of-the-art of the photonic based sensors realized as heterogeneously integrated PICs. In particular, embodiments described below are concerned with the detailed design of the PIC architecture, individual components and optical coupling structure between waveguides and active components necessary for creation of high-performance sensors for next generation of devices. Applications can be various including healthcare, life-sciences, consumer, and others.

### BRIEF DESCRIPTION OF THE DRAWINGS

FIG. 1A illustrates a device according to one embodiment of the present invention, shown in top-view.

FIG. 1B illustrates devices according to two embodiments of the present invention, shown in top-view.

FIG. 1C illustrates devices according to three embodiments of the present invention, shown in top-view.

FIG. 2 shows a device according to one embodiment of the present invention, shown in top-view and side-view.

FIG. 3 shows a device according to one embodiment of the present invention shown in top-view.

FIG. 4 shows a device according to one embodiment of the present invention shown in top-view.

FIG. 5 illustrates two embodiments of devices according to the present invention, shown in top-view.

FIG. 6 illustrates functionality of some embodiments of a device according to the present invention.

FIG. 7 illustrates a device according to one embodiment of the present invention, shown in cross section.

FIG. 8 shows a device according to one embodiment of the present invention shown in top-view.

### DETAILED DESCRIPTION

Described herein include embodiments of a heterogeneously integrated sensor and related components with improved performance leveraging dissimilar materials to improve the functionality, performance and reduce size, weight, and cost.

In the following detailed description, reference is made to the accompanying drawings which form a part hereof, wherein like numerals designate like parts throughout, and in which are shown by way of illustration embodiments in which the subject matter of the present disclosure may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

The description may use perspective-based descriptions such as top/bottom, in/out, over/under, and the like. Such descriptions are merely used to facilitate the discussion and are not intended to restrict the application of embodiments described herein to any particular orientation. The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The term “coupled with,” along with its derivatives, may be used herein. “Coupled” may mean one or more of the following. “Coupled” may mean that two or more elements are in direct physical, electrical, or optical contact. However, “coupled” may also mean that two or more elements indirectly contact each other, but yet still cooperate or interact with each other, and may mean that one or more other elements are coupled or connected between the elements that are said to be coupled with each other. In some cases, “coupled” might mean that at least some part of the optical signal from one element is incident to the other element. The term “directly coupled” means that two or more elements are in direct contact in at least part of their surfaces. The term “butt-coupled” is used herein in its normal sense of meaning an “end-on” or axial coupling, where there is minimal or zero axial offset between the elements in question. The axial offset may be, for example, slightly greater than zero in cases where a thin intervening layer of some sort is formed between the elements, such as e.g., thin coating layer typically used to provide high-reflectivity or anti-reflectivity functionality. It should be noted that the axes of two waveguide structures or elements need not be colinear for them to be accurately described as being butt-coupled. In other words, the interface between the elements need not be perpendicular to either axis in cases e.g., this interface is angled to control the reflections at the interface. No adiabatic transformation occurs between butt-coupled structures/interfaces.

Term “active device”, “active structure” or otherwise “active” element, part, component may be used herein. A device or a part of a device called active is capable of light generation, amplification, modulation and/or detection using electrical contacts. This is in contrast to what we mean by a “passive device” whose principal function is to confine and guide light, and/or provide splitting, combining, filtering and/or other functionalities that are commonly associated with passive devices. Some passive devices can provide functions overlapping with active device functionality, such as e.g., phase tuning implemented using thermal effects or similar that can provide modulation. No absolute distinction should be assumed between “active”, and “passive” based purely on material composition or device structure. A silicon device, for example, may be considered active under certain conditions of modulation, or detection of low wavelength radiation, but passive in most other situations.

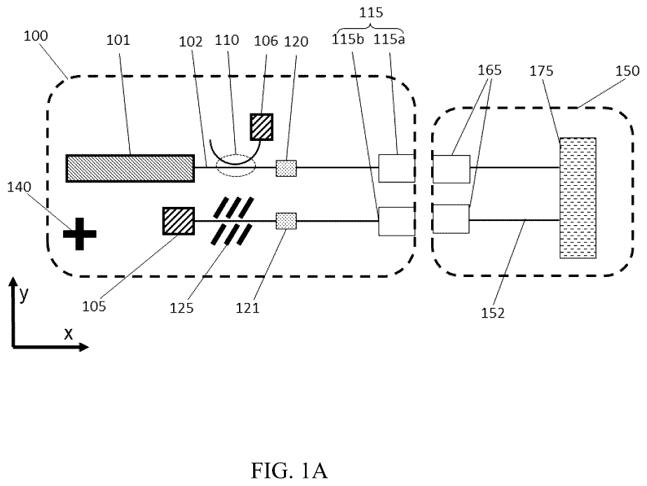

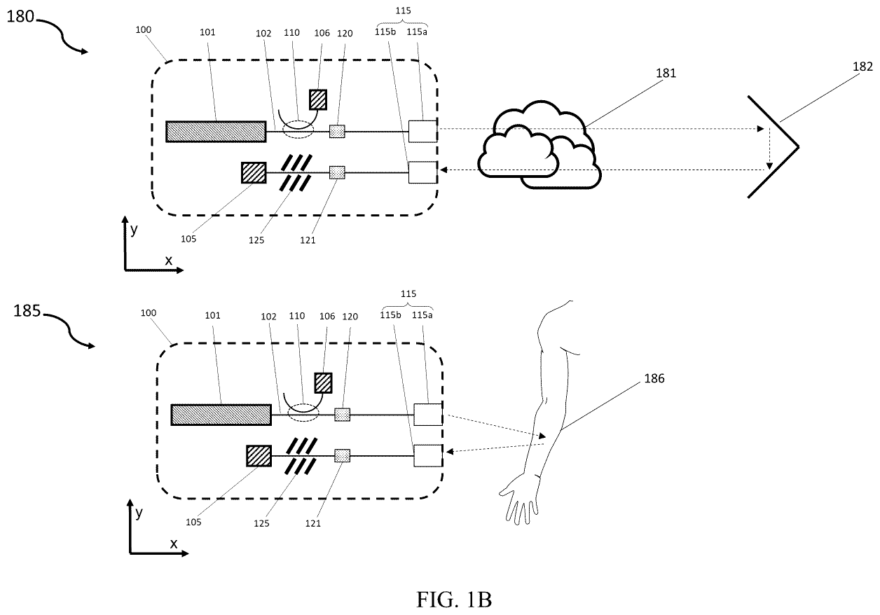

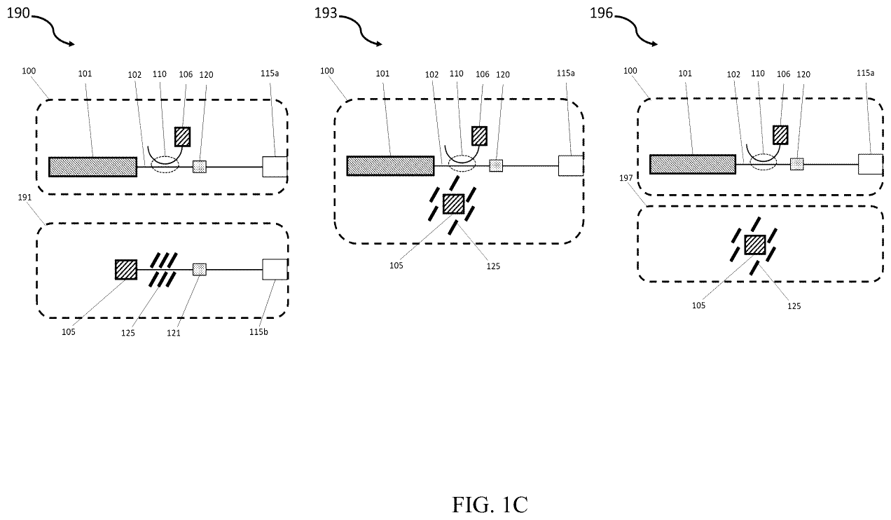

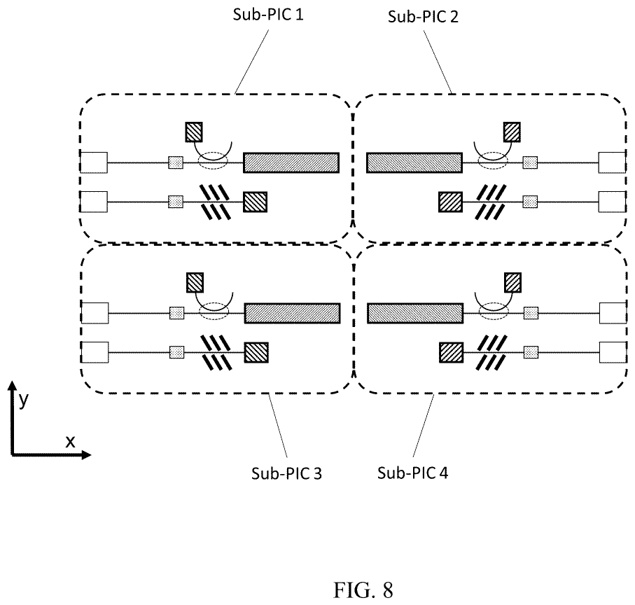

FIG. 1A is a schematic top-view of an integrated photonic device 100 showing one embodiment of an integrated sensor. In some of the embodiments described below, the integrated sensor is realized as a PIC including just one optical “unit” of the type 100 connected to an external electronic unit, while in others, the PIC includes a plurality of similar or identical “units” or “sub-systems”, the plurality sharing an external electronic unit as will be described with the help of FIG. 8. In some embodiments, integrated sensor 100 is combined with integrated photonic device 150 providing a specific analyte region (described below) which can be discarded and replaced with similar device 150 at low cost as will be described below. In other embodiments, the analyte region is in free space such as e.g., atmosphere as illustrated and explained with FIG. 1B and view 180 below. In yet other embodiments, the analyte region is another physical object such as e.g., human body as illustrated and explained with FIG. 1A and view 185 below, animal body and/or any other object whose properties and characteristics can be analyzed using the sensor in one of its embodiments. Those properties can include spectral signatures, scattering, reflection and/or transmission characteristics that can be static or change in time.

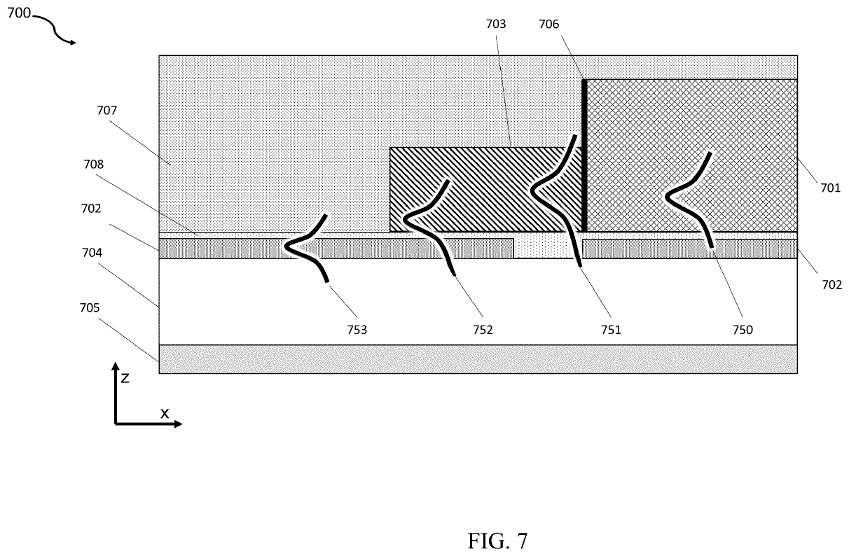

In one embodiment, the integrated sensor comprises at least three functional elements 101, 105 and 115 (comprising 115a and 115b) connected with waveguides 102. Element 101 is the optical source providing efficient light generation when injected with current. Optical source 101 can be a Fabry-Perot laser, single-frequency laser, wavelength-stabilized laser, tunable laser, widely tunable laser, mode-locked laser, broadband optical source, and/or other suitable optical sources with additional details provided in the remainder of the disclosure. Examples of tunable lasers can be tunable distributed feedback (DFB) lasers, while examples of widely tunable lasers are sampled-grating distributed Bragg reflector (SGDBR) lasers or ring-resonator based Vernier tunable lasers. The difference between the two is the tuning range, which is typically in the order of 1-2 THz or less for the tunable lasers, and typically larger than 1-2 THz for the widely tunable lasers. Common materials used to realize the optical source depend on the operation wavelength and can include InP and InP-based ternary and quaternary materials, GaAs and GaAs based ternary and quaternary materials, GaN and GaN based ternary and quaternary materials, GaP, InAs and InSb and their variations and derivatives or any other suitable material for providing direct optical emission. Optical source is efficiently coupled to the passive waveguide 102 using butt-coupled assisted structure as described with the help of FIG. 7. Signal from the optical source 101 is routed to input/output structures 115 that serves to appropriately shape the light to interact with the environment/analyte region and also couples the light to waveguides on the receive end if architecture has waveguide coupled photodetectors. Examples of input/output structures are edge couplers, grating couplers, corner reflectors and/or other structures suitable for manipulating the light including a combination of structures that also include lenses, diffusers, etc.

At least one of the photodetectors 105 is configured to receive the signal that was: (1) generated by optical source 101, (2) shaped by one of the input/output structures 115a, (3) has interacted with the relevant environment/analyte region (described below), and (4) is collected in part by at least one input/output structure 115b. The combined purpose of the optical source 101 and photodetector 115 is to monitor the changes of power between the transmitted and received signal (after interacting with the environment/analyte region) as a function of at least one of the optical source operating wavelength, optical source output intensity, time, and direction of emission (if input/output structures 115 have steering functionality). To facilitate more precise measurements, additional photodetectors (one of which is shown as photodetector 106) can be utilized to monitor optical power in multiple locations on the PIC and compare it to the powers received by photodetector 105. In such cases, monitor photodetectors can be connected via a tap-coupler 110. Tap coupler is a coupler that typically couples small amount of incident light to the output connected to photodetector while passing most of the incident light to the other output. In some embodiments <5% of power is directed towards the monitor photodetector. In other embodiments where tap coupler is not utilized, monitor photodiodes can be in-line photodiode which absorb only a small percentage of the transmitted light and convert that optical power into current or can be connected to the backside of the laser.

In embodiments where device 150 is not utilized, the device 100 can interact with various environments/analyte region. In some embodiments it can be the atmosphere as illustrated in FIG. 1B and view 180, in other embodiments it can be positioned in such way as to interact with e.g., human body as illustrated in FIG. 1B and view 185, animal body or other physical objects. In such cases, the device 100 would illuminate certain regions of atmosphere or objects and collect the returning signal as a result of reflection, scattering, transmission (if there is reflecting surface) and/or combination of both. In some embodiments, external reflectors (as illustrated with FIG. 1B and view 180) can be utilized to increase the strength of the returned signal. An example of such reflector can be a corner-reflector or other structures with generally large reflection at the wavelength of interest/operation. By measuring the transmittance and/or reflectance, identification of particular properties of the environment can be made, e.g., atomic, molecular or chemical composition can be determined as well as their concentration. In the case of environment, various pollutants, chemicals, drugs and similar can be monitored either in vicinity or at distance if beams are appropriately shaped. In the case human or animal body, various conditions can be monitored including heart rate, respiration rate, pulse oximetry, blood pressure, body temperature, hydration, blood alcohol, glucose and others. In the case of other physical objects, various properties can be monitored including surface quality, quality of various coatings, material composition, surface distortion and others. In this disclosure, all such objects/regions to be monitored are called analyte region.

In embodiments where device 150 is utilized, devices 100 and 150 are efficiently coupled using input/output structures 115 and 165. Input/output structures 165 are coupled to analyte region 175 via waveguides 152. Analyte region can be realized in various ways with an intent to provide controlled region in which light can interact with the substance to be characterized. Analyte region 175 can be a region where cladding thickness is reduced so that light interacts with the substance via evanescent field. In such cases, the interaction length can be increased using various delay elements such as spirals. In yet other cases, resonant enhancement can be utilized by forming a cavity inside the analyte region. In other embodiments, analyte region can be a channel in which substance can be inserted and light is suitable routed to be reflected back towards the second waveguide via unguided propagation. In yet other embodiments, analyte region can comprise additional chemicals to facilitate higher sensitivity to the substance of interest.

In some embodiments, the device 100 can be used multiple times by using different devices 150. In other words, one can envision large number of discardable cartridges of device 150 used for multiple sensing events with a single device 100. This can be beneficial as cost of device 150 is generally significantly lower owning to the fact that it does not comprise active optical devices (such as sources, detectors, amplifiers), in contrast to device 100. In some embodiments, device 150 can also comprise heaters to facilitate better performance by evaporating substances under test.

In some embodiments, device 100 comprises light filtering structures 125. The main purpose of light filtering structures is to prevent stray light from impacting the measurements. Stray light can be scattered directly from the optical source but can also be reflected from other locations on the chip or from elements that are external to the chip. Such reflection, in some cases, can be of comparable or even higher magnitude than the signal from the relevant environment. A light filtering structure is placed such to either absorb or reflect straylight that could otherwise be detected by photodetector 105. In some embodiments, light filtering structures can be realized from III/V materials. In some other embodiments, light filtering structures can be realized from metals. In some other embodiments, light filtering structures can be deposited after fabrication of chip is complete. Such light filtering structures, which are deposited after the chip is made, can be opaque polymers or other suitable elements. Multiple various structures can be combined to improve the light filtering characteristics of structure 125. In some embodiments, thin film structures providing wavelength dependent filtering can be utilized. In yet other embodiments, combination of III/V materials, metal and other suitable materials can be utilized.

In some embodiments, device 100 comprises modulator structures 120 and/or 121. The main purpose of modulator structures is to control at least one of the amplitude and phase of the emitted and/or received signals. This can enable operation with large background noise, e.g., constant optical signal of similar wavelength, as modulation can be suitably detected and filtered out from the background noise. In other embodiments, in can enable discrimination between multiple input/output structures coupled to same or multiple detectors. In such embodiments, output from source 101 could be suitably split into at least two input/output structures, and modulation could enable one to discriminate between the two by properly detecting and demodulating the signal at the photodetector. Similarly, modulator 121 on the receiving end can be suitably used to e.g., convert phase modulation to amplitude modulation or similar (when e.g., configured into an interferometer structure) to facilitate simplified detection.

FIG. 1B shows two embodiments of integrated photonics devices according to present invention. In view 180, integrated photonic device is configured to sense free space such as e.g., atmosphere 181. Optional reflector elements 182 such as corner-reflector can be used to increase the strength of the returned signal. In some embodiments, various other objects can be utilized as reflectors such as e.g., buildings, mountains, etc.

In view 185, integrated photonic device is configured to sense characteristics of human body. Various arrangements can be utilized, in which nominally light enters human body and is scattered and/or reflected before being detected. Similarly, animal body and/or other objects can be analyzed. If integrated photonic device is realized from multiple elements, as described with the help of FIG. 1C, transmission through human body, animal body and/or other objects can also be used to analyze their characteristics.

FIG. 1C shows three embodiments of integrated photonics devices according to present invention describing some variations on utilization of photodetectors as a part of the integrated sensor. In view 190, photodetector 105, one of input/output structures 115b, optional light filtering structures 125 and optional modulator structures 121 are part of a separate integrated photonic device 191. This allows for bistatic operation, and further optimization of the complete system. In view 193, photodetector 105 and optional light filtering structures 125 are on the same integrated photonic device 100, but photodetector 105 is not coupled through waveguides and operates as surface-normal or free-space photodetector. Detector, in case of embodiments shown in view 193 can be heterogeneously integrated with the chip 100 or can be assembled using hybrid integration as alignment requirements are significantly relaxed for free-space/surface-normal detectors. In view 196, the surface-normal or free-space detector 105 and optional light filtering structures 125 are part of a separate integrated photonic device 197, providing additional flexibility in optimizing the complete system, including the bistatic operation.

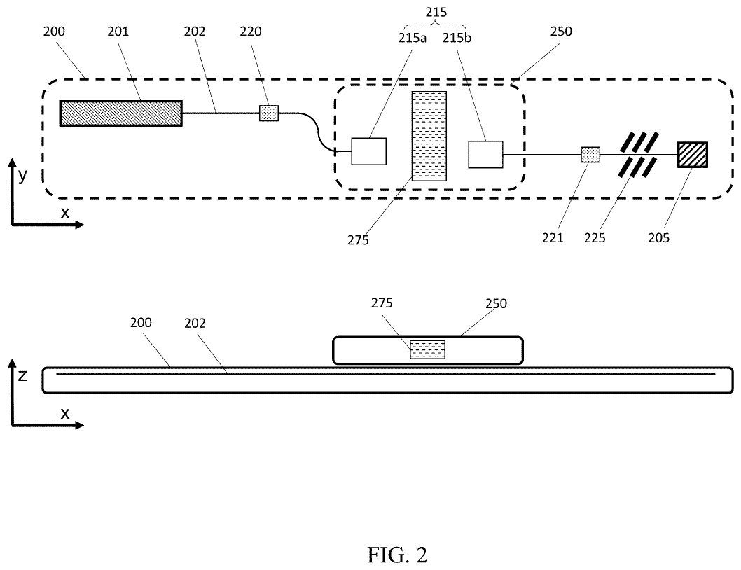

FIG. 2 is a schematic top-view and side view of an integrated photonic device 200 showing one embodiment of an integrated sensor. Elements 201 to 275 (unless explicitly defined differently) correspond to elements 101 to 175 as described in relation to FIG. 1A. Similarly to embodiment described with the help of FIGS. 1B and 1C, a plurality of units can be combined and share a common external electronic unit. Furthermore, in some embodiments, integrated sensor 200 is combined with integrated photonic device 250 providing a specific analyte region which can be discarded and replaced with similar device 250 at low cost. In other embodiments, operation similar to one described with help of FIG. 1B can be utilized with different analyte regions. In such embodiments, device 250 is not used, and out-of-plane emission is utilized to interact with free-space and/or other objects (analyte region). In yet other embodiments, bistatic architectures and/or free-space/surface-normal detectors can be utilized as described with the help of FIG. 1C.

In the embodiments shown in FIG. 2, the integrated sensor is configured to have at least two input/output structures 215a and 215b configured for out-of-plane emission (as determined from the propagation inside the waveguide 202) and receiving of the optical signals. Examples of such structures are grating couplers and corner reflectors, which can furthermore comprise lenses, diffusers, etc.

In embodiments where device 250 is not utilized, the device 200 can interact with various environments as also described above with a difference that shaping of the beam is done in out-of-plane direction.

In embodiments where device 250 is utilized, device 250 comprises an analyte region 275 that is suitably designed such as that the optical signals emitted by input-output structure 215a efficiently interact with the analyte before being collected in part by the second input-output structure 215b. In some embodiments, mirror like structures are utilized in at least part of the device 250 to increase the strength of returned signal to photodetector 205. The cost of device 250 can be further reduced from the cost of the device 150 due to further simplified manufacturing process as it does not comprise in-plane photonic waveguides and elements, but only analyte channels and optional mirrors and beam focusing elements. In some embodiments, device 250 can also comprise heaters to facilitate better performance by evaporating substances under test.

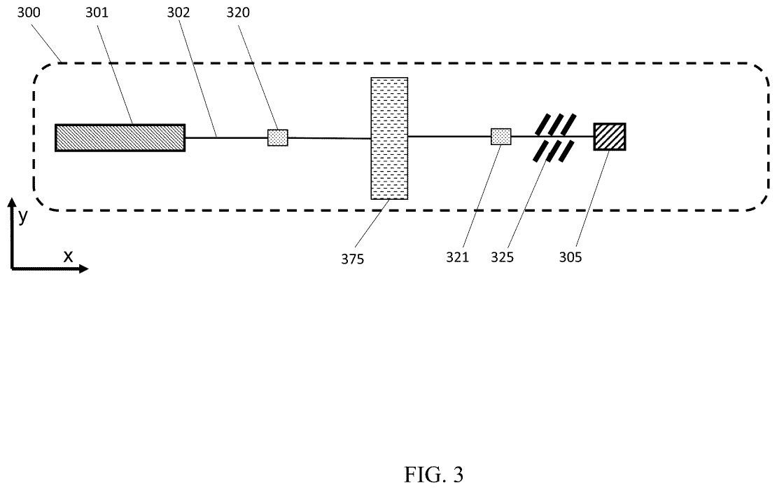

FIG. 3 is a schematic top-view of an integrated photonic device 300 showing one embodiment of an integrated sensor. Elements 301 to 375 (unless explicitly defined differently) correspond to elements 101 to 175 as described in relation to FIG. 1A. Similarly to embodiment described with the help of FIGS. 1B and 1C, a plurality of units can be combined and share a common external electronic unit. In this embodiment, in contrast to embodiments described in relation to FIGS. 1 and 2, the analyte region 375 is a part of the device 300. Integration of analyte region 375 in this way can enable smaller devices, and also provide increased signal-to-noise ratios due to lower coupling losses between the optical source 301, analyte region 375 and photodetector 305. In some embodiments, the analyte region is defined to operate in transmission, in other embodiments the analyte region is defined to operate in reflections/scattering, and in yet other embodiments the analyte region comprises waveguides for evanescent interaction between the optical mode and the substances under test.

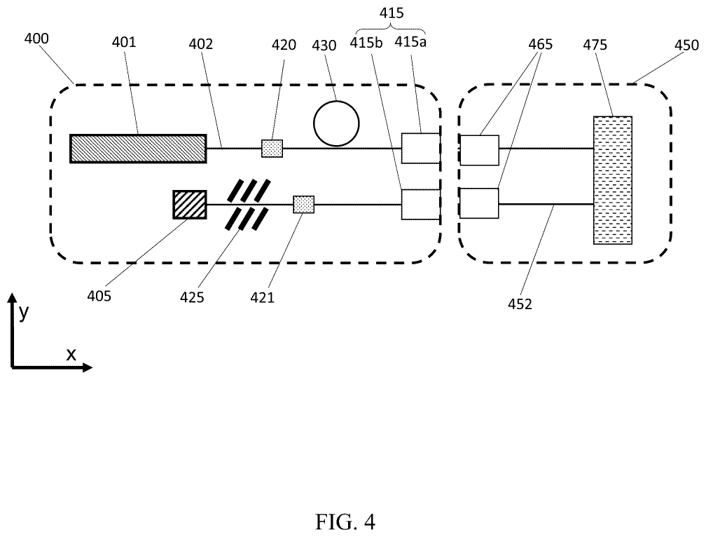

FIG. 4 is a schematic top-view of an integrated photonic device 400 showing one embodiment of an integrated sensor in which the optical source is further optimized as will be described below. This optimization can be applied to any of the embodiments described herein. Elements 401 to 475 (unless explicitly defined differently) correspond to elements 101 to 175 as described in relation to FIG. 1A.

A new element, resonator 430, is introduced. Resonator 430 is optically coupled to optical source 401 and is configured such that it generates an optical comb from single-frequency input from optical source 401. Optical source 401 can be tunable to provide change of the central frequency of the comb. The resonator 430 can be structured in all-pass configuration (as shown in FIG. 4) or in other configurations such as add-drop. In some embodiments, backscattering from the resonator 430 is utilized to provide feedback and injection lock the optical source to the resonator 430. This can help facilitate single-frequency operation (improving sidemode suppression ratio) as well as reduce the phase noise of the optical source. In embodiments shown in FIG. 4, optional modulator structure 420 is utilized to facilitate more efficient comb generation and/or injection locking by adjusting the phase of the optical signal. In other embodiments, bistatic architectures and/or free-space/surface-normal detectors can be utilized as described with the help of FIG. 1C or device 400 can be configured to interact with free-space and/or objects as described with the help of FIG. 1B.

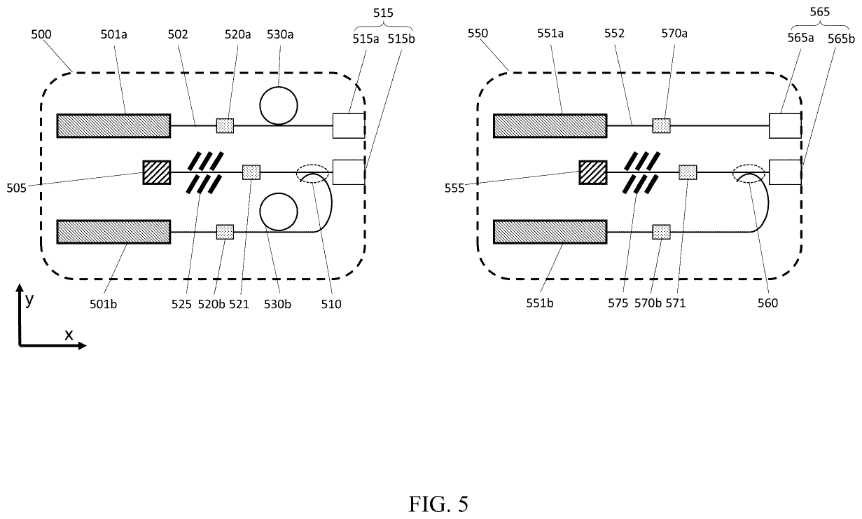

FIG. 5 shows two schematic top-views of integrated photonic devices 500 and 550 showing embodiment of an integrated sensor in which the optical source and architecture is further optimized as will be described below. This optimization can be applied to any of the embodiments described herein. Elements 501 to 525 (unless explicitly defined differently) correspond to elements 101 to 125 as described in relation to FIG. 1A. Similarly, elements 551 to 575 correspond to elements 101 to 125 as described in relation to FIG. 1A.

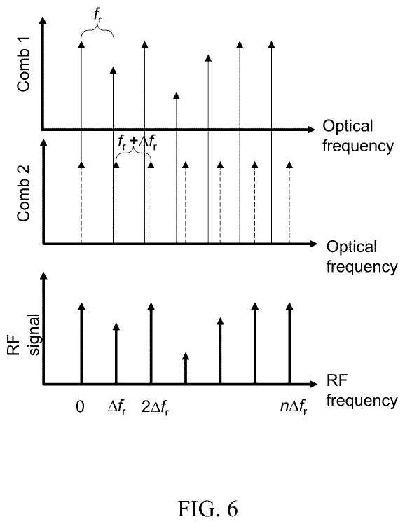

In the device shown in 500, the optical source 501a is a comb source and utilizes resonator 530a and optional modulator structure 520a to generate a comb as described with the help of FIG. 4. Similarly, a second group of optical source 501b, resonator 530b and optional modulator structure 520b generates a second comb (comb source) with slightly different repetition rate as will be described with the help of FIG. 6. Repetition rate of a resonator-based comb is defined by the roundtrip time inside the resonator, so such adjustments can easily be made by changing at least one of the length of the resonator and the width of the waveguide inside the resonator (impacting the phase/group velocity). The second comb, in some embodiments, is coupled to the same waveguide that is also connected to input/output structure 515b and photodetector 505 through a coupler 510. Examples of such coupler structures are directional couplers, adiabatic couplers, Y-junctions and/or multi-mode interference (MMI) couplers, and or other structures capable of combining the input from two waveguides into a single waveguide. In other embodiments, one comb is coupled to photodetector 505 from one of the sides, and the other comb is coupled to photodetector 505 from the other side.

In the device shown in 550, the optical source 551a is a mode-locked laser whose output also generates a comb of frequencies (comb source). Similarly, a second optical source 551b is a mode-locked laser with different repetition frequency and correspondingly different spacing between the comb lines (comb source). Such adjustments can be made by changing the cavity length of the mode locked lasers, changing the number and position of the absorber regions, and/or other adjustments resulting with the change of the repetition frequency. The second comb, in some embodiments, is coupled to the same waveguide that is also connected to input/output structure 565b and photodetector 555 through a coupler 560. Examples of such coupler structures are directional couplers, adiabatic couplers, Y-junctions and/or multi-mode interference (MMI) couplers, and or other structures capable of combining the input from two waveguides into a single waveguide. In other embodiments, one comb is coupled to photodetector 555 from one of the sides, and the other comb is coupled to photodetector 555 from the other side.

FIG. 6 explains the benefits of using two combs with slightly different line spacing for spectroscopy. Comb 1 in FIG. 6 has line spacing equal to fᵣ (first repetition frequency) and is interacting with the substance under test (analyte region). This interaction results with the change in the amplitude of individual comb lines either due to absorption, reflection and/or scattering before being incident on the photodetector. Comb 2 in FIG. 6 has line spacing equal to fᵣ+Δfᵣ (second repetition frequency) which is different from the repetition rate of Comb 1 by Δfᵣ. The Comb 2 goes directly to the photodetector without its amplitude being changed from the interaction with the substance under test. As combs are incident on the photodetector, their signal is downconverted to RF domain where each pair of comb lines is converted to a different RF frequency separated from other comb lines by multiples of the repetition rate difference Δfᵣ. With this precisely controlled downconversion, direct measurements of the changes in the Comb 1 lines are possible in the RF domain. Dual-comb spectroscopy (DCS) offers an unprecedented opportunity to simultaneously acquire broadband and high-resolution spectra within microseconds and is characterized by high signal-to-noise ratio, small footprint, and implementation free of moving parts.

FIG. 7 is a schematic cross-section view of an integrated photonic device 700 utilizing butt-coupling for efficient coupling between dissimilar materials where one material provides the core of the (passive) waveguide 702, while other layer 701 comprises what is commonly called active device supporting light generation, amplification, detection, and/or modulation. The integration of actives and passives in some embodiments of integrated sensor are realized in this way.

The exemplary cross-section includes a substrate 705 that can be any suitable substrate for semiconductor and dielectric processing, such as Si, InP, GaAs, quartz, sapphire, glass, GaN, silicon-on-insulator and/or other materials known in the art. In the shown embodiment, a layer of second material 704 is deposited, grown, transferred, bonded or otherwise attached to the top surface of substrate 705 using techniques known in the field. The main purpose of layer 704 is to provide optical cladding for material 702 (to be described in more detail below), if necessary to form an optical waveguide. Optical waveguides are commonly realized by placing higher refractive index core between two lower refractive index layers to confine the optical wave. In some embodiments, layer 704 is omitted and substrate 705 itself serves as a cladding.

Layer 702 is deposited, grown, transferred, bonded or otherwise attached to the top of layer 704 if present, and/or to the top of substrate 705, using techniques known in the field. The refractive index of layer 702 is higher than the refractive index of layer 704 if present, or, if layer 704 is not present, the refractive index of layer 702 is higher than the refractive index of substrate 705. In one embodiment, the material of layer 702 may include, but is not limited to, one or more of SiN, SiNOx, TiO₂, Ta₂O₅, (doped) SiO₂, LiNbO₃ and AlN, characterized by bandgap greater than 1.2 eV. In some embodiments, other common dielectric materials may be used for layer 702. In other embodiments, a high-bandgap semiconductor material may be used for layer 702, such as e.g., GaN, InGaP or AlGaAs. In yet other embodiments, other semiconductor materials such as Si can be utilized. In some embodiments refractive index of layer 702 is between 1.44 and 2.5. Either or both of layers 704 and 702 can be patterned, etched, or redeposited to tailor their functionality (define waveguides, splitters, couplers, gratings and other passive components) as is common in the art. Layer 102 corresponds to a core of the passive waveguide structure.

Layer 708, whose refractive index is lower than the refractive index of layer 702, overlays layer 702 and underlays layers 701 and 703, and serves to planarize the patterned surface of layer 702. In some embodiments, the planarity of the top surface of layer 708 is provided by chemical mechanical polishing (CMP) or other etching, chemical and/or mechanical polishing methods. In other embodiments, the planarity is provided because of the intrinsic nature of the method by which layer 708 is deposited, for example if the material of layer 708 is a spin-on glass, polymer, photoresist or other suitable material. The planarization may be controlled to leave a layer of desired, typically very low, thickness on top of the layer 702 (as shown in FIG. 7), or to remove all material above the level of the top surface of the layer 702 (not shown). In the case layer 708 is left on top of layer 702, the target thicknesses are in the range of 10 nm to several hundreds of nm, with practical thickness includes the typical across wafer non-uniformity of the planarization process. In some embodiments, spin-on material is used to planarize and is then etched back resulting with improved across wafer uniformity compared to typical CMP processes.

Layer 701 is bonded (attached) on top of the whole or part of the corresponding (708, 702) top surface. Said bonding can be direct molecular bonding or can use additional materials to facilitate bonding such as e.g. metal layers or polymer films as is known in the art. Layer 701 makes up what is commonly called an active device, and may be made up of materials including, but not limited to, InP and InP-based ternary and quaternary materials, GaAs and GaAs based ternary and quaternary materials, GaN and GaN based ternary and quaternary materials, GaP, InAs and InSb and their variations and derivatives or any other suitable material for providing direct optical emission. Layer 701 in some embodiment is multilayered, comprising sublayers providing both optical and electrical confinement as well as electrical contacts, as is known in the art for active devices. Sublayers of layer 701 in some embodiments provide vertical confinement (up/down in FIG. 7), while the lateral confinement (surface normal to the cross-section shown in FIG. 7) and the facet toward layers 706 (if present) and/or layer 703 is provided by at least one etch, after attachment of layer 701, as is known in the art for active devices. Layer 701 corresponds to active waveguide structure.

In some embodiments, layer 701 can be efficiently electrically pumped to generate optical emission and gain. In other embodiments, layer 701 can provide modulation and/or detection functionality. The present invention enables efficient optical coupling between waveguides formed in layer 701 and waveguide whose core is formed in layer 702. Said materials 702 can provide additional functionality such as low propagation loss, wide-band transparency, high intensity handling, combining, splitting, and filtering of light, out-of-plane emission, non-linear generation and/or others as is known in the art.

Efficient coupling is facilitated by layer 703, and, in cases where layer 706 is present, by layer 706. Optional layer 706 primarily serves as either an anti-reflective or a highly reflective coating at the interface between layer 701 and layer 703. Layer 703 serves as an intermediate waveguide that in some embodiments accepts the profile (depicted by line 750) of an optical mode supported by the waveguide for which layer 701 provides the core, captures it efficiently as mode profile 751, and gradually transfers it to mode profiles 752, and finally 753. Mode profile 753 is efficiently coupled to the waveguide for which layer 702 provides the core.

Layer 703 dimensions and refractive index can be engineered to facilitate efficient butt-coupling of mode profile 750 and to efficiently transform the mode to one with mode profile 753 by taking advantage of tapered structures made in at least one of the layers 702 and 703. In some embodiments, refractive index of layer 703 is smaller than the refractive index of layer 702. In some embodiments the refractive index of layer 703 is between 1.44 and 2.2. Thickness of layer 103 is an optimization parameter, and in some embodiments it is between 400 nm and 4000 nm, thickness largely being dependent on details of the layer 701 design and position and shape of the mode 750. The use of intermediate layer 703 significantly improves efficient transfer between high refractive index materials (such as e.g., III/V materials or similar in layer 701) to lower refractive index materials (such as e.g., SiN in layer 702).

The transformation from mode 751 to mode 753 utilizes adiabatic tapering between the two layers 702 and 703, with a dominant transition happening when there is phase matching between the mode dominantly residing in layer 702 and the mode dominantly residing in layer 703. As this phase matching can be engineered to happen at relatively large waveguide widths, the need for very fine taper tips can be fully removed. In some cases, tapers as wide as e.g., 200 nm or wider can support efficient transmission enabling high fabrication yield even if standard lithography is utilized. In other cases, narrower tapers, e.g., with width approaching 100 nm, can be utilized which can also be fabricated using high-quality DUV lithography enabling high-throughput fabrication.

Differences between the optical modes supported by waveguides in layers 701 and 702 respectively may or may not be obvious by observation of the mode profiles, but mode overlaps less than 100% and vertical offset (in FIG. 7) between modes 750 and 753 could (in the absence of intermediate layer 703) result in significant optical loss. In some cases, it may be considered that losses of up to 2 dB are acceptable, but losses greater than that are not. In other cases, a 5 dB loss level may be the criterion chosen. The function of layer 703 is to keep optical coupling loss due to imperfect mode overlap and vertical offset (between modes 750 and 753) below whatever is determined to be an acceptable level in a given application.

The upper cladding layer 707 for waveguides realized in 703 and/or 702 can be ambient air (meaning no cladding material is actually deposited) or can be any other deliberately deposited suitable material as shown in FIG. 7, including, but not limited to, a polymer, SiO₂, SiN, SiNOx etc. In some embodiments same material is used for layer 707 and layer 708. In some embodiments (not shown), layer 707 cladding functionality can be provided with multiple depositions, e.g., one material provides the cladding for mode 753 guided by core formed in layer 702, and another material provides the cladding for mode 751 guided by core formed in layer 703. In yet another embodiment (not shown), layer 703 can provide cladding functionality to layer 702 and mode 753 in at least part of the structure.

One or more lithography alignment marks (not shown in this cross-sectional view, but see, for example, 140 in FIG. 1A) are present to facilitate precise alignment between the layers formed during various processing steps. This alignment using photolithography and common alignment marks enables fast and efficient bonding of layer 701, as no fine alignment is needed in this step while extreme precision (down to the resolution of the stepper tool which can be <100 nm for deep-ultraviolet tools) is provided during subsequent semiconductor processing.

FIG. 8 is a schematic top-view of an embodiment of integrated photonic device comprising a plurality of similar or identical interconnected “units” or “sub-systems. Any of the embodiments described above can be one of the sub-systems or units combined to form the plurality. Said plurality can share the same fabrication process flow as described with the help of FIG. 7 and be on the same substrate, or each sub-system can be fabricated separately and assembled. Furthermore, different sub-units can be utilized to form the plurality. One of the benefits of forming the complete system from a plurality of sub-units is the ability to include sub-units optimized for operation at different wavelength ranges. Another benefit is the improved robustness in the case one of the sub-units fail. The embodiment shown in FIG. 8 has multiple separate optical sources, four of which are shown but can be any other number. Each source can operate at different wavelengths providing additional information to detect and characterize substance under test.

The integrated sensor can be designed to operate at various wavelengths. In some cases, operation in visible wavelength range is preferred, and optical source in such embodiments can utilize GaN and GaAs based active materials. In other cases, operation in near-visible (e.g., 850 nm, 940 nm, 980 nm) is preferred—in such cases GaAs based active materials can be utilized for the optical source. In yet other embodiments, operation at longer wavelength range can be preferred (e.g., 1380 nm, 1550 nm or similar). In such embodiments InP based active materials can be utilized for the optical source. In yet other embodiments, the active structures are utilizing quantum dots, so operation around 1300 nm can be supported by GaAs based actives. In yet other embodiments, operation at yet longer wavelengths is preferred, such as beyond 2 μm wavelength. In such cases the use of quantum cascade and interband cascade lasers and materials can be preferred. In yet other embodiments, operation at multiple wavelengths might be preferred. In all cases, the waveguides have to support the full operating wavelength range of the system which is done by selecting appropriate materials that provide low material losses in the wavelength range of interest.

The sensor PIC may be combined with a lens and/or diffuser system to control and shape the emitter and received beams.

It is to be understood that these illustrative embodiments teach just several examples of heterogeneously integrated sensors utilizing present invention and many similar arrangements can be further envisioned. Furthermore, such sensors can be combined with multiple other components to provide additional functionality or better performance such as various filtering elements, amplifiers, monitor photodiodes, modulators and/or other photonic components.

Embodiments of the present invention offer many benefits. The integration platform enables scalable manufacturing of PICs made from multiple materials providing higher-performance and/or ability to operate in broadband wavelength range. Furthermore, the platform is capable of handling high optical power compared to typical Si waveguide-based or InP waveguide-based PICs.

This present invention utilizes a process flow consisting of typically wafer-bonding of a piece of compound semiconductor material on a carrier wafer with dielectric waveguides (as is described with the help of FIG. 7) and subsequent semiconductor fabrication processes as is known in the art. It enables an accurate definition of optical alignment between active and passive waveguides via typically photo lithography step, removing the need for precise physical alignment during bonding (attachment). Said photo lithography-based alignment allows for scalable manufacturing using wafer scale techniques.

It is to be understood that optical coupling between modes in active and passive layers is reciprocal, so that, taking FIG. 7 as exemplary, the structure can be configured to facilitate light transmission from region 701 to region 702, but also to facilitate transmission in the reverse direction, from region 702 to region 701. In is to be understood that multiple such transitions with no limitation in their number or orientation can be realized on a suitably configured PIC.

Other approaches have relied on die attachment of prefabricated optical active devices to passive waveguides. This requires very stringent alignment accuracy which is typically beyond what a typical die-bonder can provide. This aspect limits the throughput of this process as well as the performance of optical coupling.

In some embodiments the active device can utilize the substrate for more efficient thermal sinking, due to direct contact to the substrate with no dielectric in-between.

In some embodiments, the active device creates a hybrid waveguide structure with dielectric layers which can be used, for example, to create a wavelength selective component formed inside the laser cavity for e.g., distributed feedback (DFB) lasers or similar components.

Embodiments of the optical devices described herein may be incorporated into various other devices and systems including, but not limited to, various computing and/or consumer electronic devices/appliances, industrial systems, communication systems, medical devices, sensing systems and other areas that can benefit from small size sensors.

It is to be understood that the disclosure teaches just few examples of the illustrative embodiment and that many variations of the invention can easily be devised by those skilled in the art after reading this disclosure and that the scope of the present invention is to be determined by the following claims.

1. A device comprising:
at least one of first, second and third elements fabricated on a common substrate;
wherein at least one of the first elements comprises an active waveguide structure supporting an active optical mode, at least one of the second elements comprises a passive waveguide structure supporting a passive optical mode, and at least one of the third elements, at least partly butt-coupled to at least one of the first elements, comprises an intermediate waveguide structure supporting intermediate optical modes;
wherein at least one of the first elements comprises a first optical source;
wherein at least one of the second elements comprises at least one input/output structure configured to interact with an analyte region; and
wherein mutual alignments of the first, second and third elements are defined using lithographic alignment marks that facilitate precise alignment between layers formed during processing steps of fabricating the first, the second and the third elements.

2. A device of claim 1,
wherein the active waveguide structure is defined by at least one etch after attachment to the common substrate.

3. A device of claim 1,
wherein an output from the first optical source after interacting with the analyte region is incident to at least one photodetector.

4. A device of claim 1,
wherein the analyte region is a part of an integrated photonic device comprising at least two input/output structures.

5. A device of claim 1,
wherein the analyte region is a part of human or animal body.

6. A device of claim 1,
wherein a signal from the input/output structure is incident to at least one reflector.

7. A device of claim 1,
wherein at least one of the second elements further comprises at least one tap coupler and at least one of the first elements further comprises at least one photodetector configured to monitor the first optical source before interacting with the analyte region.

8. A device of claim 1,
wherein the first optical source is a widely tunable laser.

9. A device of claim 1,
wherein the first optical source is a comb source.

10. A device of claim 1,
wherein the input/output structure is realized as one of edge couplers or grating couplers.

11. A device of claim 9,
wherein at least one of the first elements comprises a second optical source that is a comb source;
wherein a repetition rate of the second optical source is different from a repetition rate of the first optical source; and
wherein at least part of the signal from both the first optical source and the second optical source are coupled to at least one photodetector realized in one of the first elements.

12. A device of claim 1,
wherein at least one of the first elements or second elements comprises at least one modulator structure configured to control at least one of an amplitude or a phase of the signal.

13. A device of claim 11,
wherein at least one of the first elements or second elements comprises at least one modulator structure configured to control at least one of the amplitude or the phase of the signal.

14. A device of claim 1,
wherein at least one of the first elements or second elements comprises at least one light filtering structure.

15. A device of claim 11,
wherein at least one of the first elements or second elements comprises at least one light filtering structure.

16. A sensor comprising:
a first optical source coupled to a first input/output structure, a first input/output structure coupled to an analyte region, and an analyte region coupled to a photodetector;
wherein the optical source is one of tunable laser or comb source; and
wherein at least first optical source and first input/output structure are fabricated on a common substrate.

17. A sensor of claim 16,
further comprising at least one light filtering structure configured to reduce a coupling of stray light to the photodetector.

18. A sensor of claim 16,
wherein the first optical source is a comb source;
further comprising a second optical source that is a comb source wherein repetition rates of the first optical source and the second optical source are different;
wherein at least part of a signal from both the first optical source and the second optical source are coupled to at least one photodetector.

19. A sensor of claim 18,
further comprising at least one light filtering structure configured to reduce the coupling of stray light to at least one photodetector.

20. A sensor of claim 19,
further comprising at least one modulator structure configured to control at least one of an amplitude or a phase of the signal from at least one of the optical sources.
